(19) United States
(12) Patent Application Publication
(10) Pub. No.: US 2007/0017116 A1
(43) Pub. Date: Jan. 25, 2007

(54) Rechargeable nail dryer

(76) Inventor: Tae-Kook Bahn, Gyeonggi-Do (KR)

Correspondence Address: YOUNG & THOMPSON, 745 SOUTH 23RD STREET, 2ND FLOOR, ARLINGTON, VA, 22202, US

(21) Appl. No.: 11/186,805

(22) Filed: Jul. 22, 2005

(51) Int. Cl. F26B 25/06; H01M 10/42

(52) U.S. Cl. 34/202; 429/49

(57) ABSTRACT

A rechargeable nail dryer is provided. The rechargeable nail dryer with an added charge circuit provides a convenient use and reduces the expense of replacing one-time use batteries by charging a built-in rechargeable battery, and additionally minimizes a memory effect of the built-in battery by simultaneously performing a constant-current equalizing charge, a full charge, a floating charge, and a trickle charge. The rechargeable nail dryer includes a constant-current supplier for supplying a charge voltage by making a current for a rechargeable battery constant, a full-charge sensor for sensing a charge amount of the battery, a trickle oscillator for generating a driving signal of a trickle charge according to a full-charge detected signal generated from the full-charge sensor, and a trickle driver for trickle-charging a battery with a current supplied from the constant-current supplier according to a driving signal generated from the trickle oscillator.

### BACKGROUND OF THE INVENTION

1. Field of the Invention

The present invention relates to a rechargeable nail dryer, and more particularly, to a rechargeable nail dryer with an added charge circuit for providing a convenient use and reducing the expense of replacing one-time use batteries by charging a built-in rechargeable battery, and additionally for minimizing a memory effect of the built-in battery by simultaneously performing a constant-current equalizing charge, a full charge, a floating charge, and a trickle charge.

2. Description of the Related Art

A nail dryer is used to dry moisture from hands and skin and for manicure purposes. The moisture is removed through dried air generated by operating a driving fan.

A nail dryer includes a driving fan having variable speed adjustment, a sensor for sensing a physical presence to operate a driving fan intermittently or continuously, and a controller for controlling a driving fan according to a signal from the sensor.

Once the physical presence is detected by the sensor, the controller operates a driving fan and executes a drying process by outputting wind. When a physical presence is not detected by the sensor, the driving fan will be turned off during an operation.

The nail dryer uses a one-time use battery as a power source. Accordingly, a new battery needs to be replaced when a built-in battery is fully discharged. The nail dryer can be continuously used after the discharged battery is replaced by a new fully charged battery. If there is no new battery on hand, the nail dryer cannot be used further, even if there is a usable power source in its vicinity.

Moreover, since a conventional nail dryer only uses a one-time use battery, the expense of replacing the one-time use battery is a financial burden for a consumer.

### SUMMARY OF THE INVENTION

Accordingly, the present invention is directed to a rechargeable nail dryer that substantially obviates one or more problems due to limitations and disadvantages of the related art.

An object of the present invention is to provide a rechargeable nail dryer with an added charge circuit for providing a convenient use and reducing the expense of replacing one-time use batteries by charging a built-in rechargeable battery, and additionally for minimizing a memory effect of the built-in battery by simultaneously performing a constant-current equalizing charge, a full charge, a floating charge, and a trickle charge.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a rechargeable nail dryer including a constant-current supplier for supplying a charge voltage by making a current for a rechargeable battery constant, a full-charge sensor for sensing a charge amount of the battery, a trickle oscillator for generating a driving signal of a trickle charge according to a full-charge detected signal generated from the full-charge sensor, and a trickle driver for trickle-charging the battery with a current from the constant-current supplier according to the driving signal generated from the trickle oscillator.

The trickle oscillator includes a trickle-charge signal generator for generating a driving signal for a trickle charge when a full-charge detected signal is generated from the full-charge sensor, a first inverter for phase-inverting the full charge detected signal from the full-charge sensor, a second inverter for phase-inverting the driving signal from the trickle charge signal generator, an OR gate for performing an OR-operation on signals from the first inverter and the second inverter and producing a result signal thereof, and a third inverter for producing a driving signal of trickle charge by phase-inverting a signal from the OR gate.

The trickle driver includes a zener diode for making a voltage supplied from the constant-current supplier a constant voltage, a drive field effect transistor (FET) for generating a drive voltage using a current supplied from the zener diode according to a drive signal from the trickle oscillator, and a charge FET for supplying a charge current to the battery in response to a signal generated from the drive FET.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating a configuration of a rechargeable nail dryer according to the present invention;

FIG. 2 is a circuit diagram of a constant-current supplier shown in FIG. 1;

FIG. 3 is a circuit diagram of a full-charge sensor shown in FIG. 1;

FIG. 4 is a circuit diagram of a trickle oscillator shown in FIG. 1; and

FIG. 5 is a circuit diagram of a trickle driver shown in FIG. 1.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

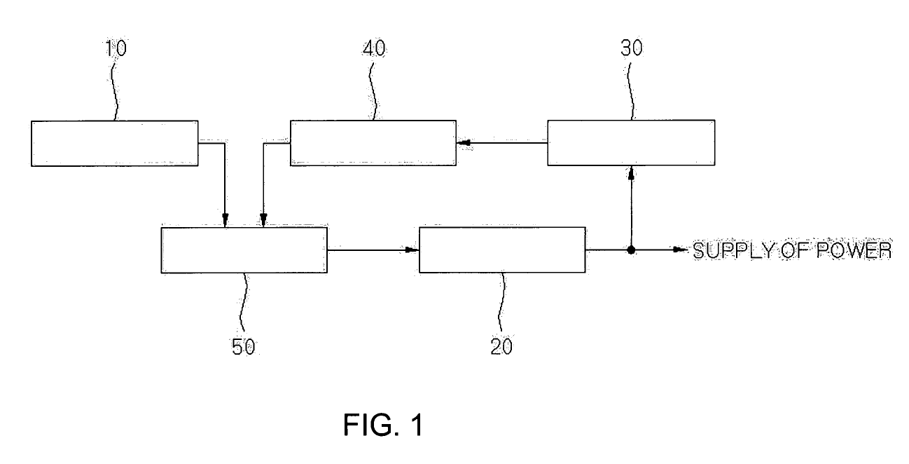

FIG. 1 is a block diagram illustrating a configuration of a rechargeable nail dryer according to the present invention. A reference number 10 represents a constant-current supplier for supplying a charge voltage by making a current for a rechargeable battery 20 constant. A reference number 30 represents a full-charge sensor for sensing a charge amount of the battery 20. A reference number 40 represents a trickle oscillator for generating a driving signal of a trickle charge according to a full-charge detected signal generated from the full-charge sensor 30. A reference number 50 represents a trickle driver for trickle-charging the battery 20 with a current supplied from the constant-current supplier 10 according to a driving signal generated from the trickle oscillator 40.

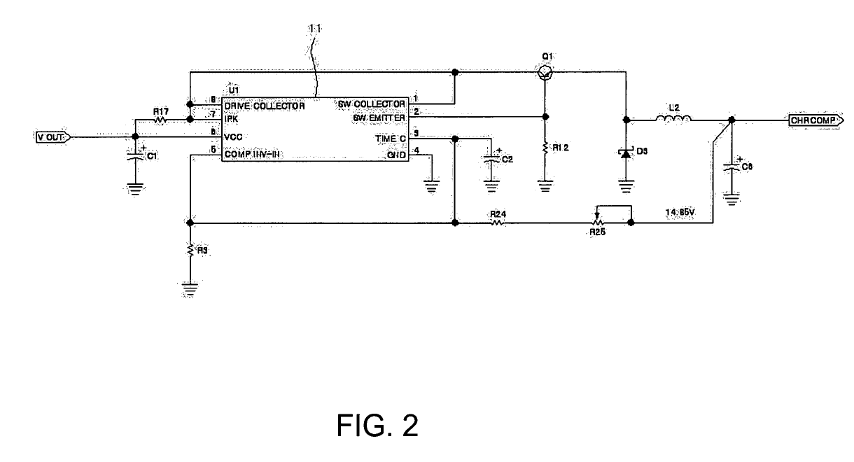

Referring to FIGS. 1 to 5, operations of a rechargeable nail dryer will now be made in detail according to the present invention.

First of all, the principle of a charging method will now be explained. A driving signal is generated from a driver 11 in the constant-current supplier 10 and a switch Q1 is turned on to generate a charge voltage according to the driving signal. The charge voltage is supplied to a trickle driver 50 through an inductance L2 and a condenser C6 in a constant-voltage and constant-current state by a zener diode.

The trickle driver charges the battery 20 with the constant current.

Once charge begins, the full-charge sensor 30 detects a charge amount of the battery 20 and transmits a detected signal to the trickle oscillator 40.

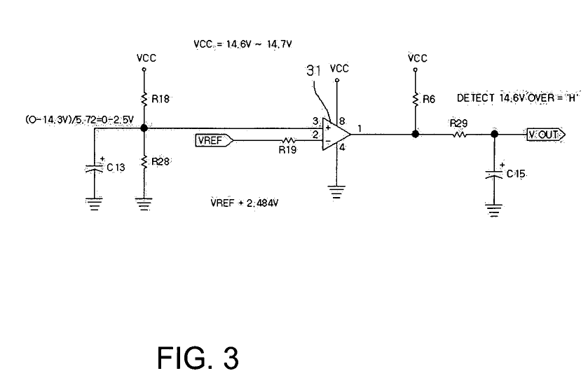

That is, the full-charge sensor 30 divides a charge voltage of the battery 20 with resistances R10 and R20 as shown in FIG. 3. A comparator 31 compares the divided voltage with a reference voltage VREF to generate a full-charge detected signal according to whether a voltage is small or large. Here, a high signal H is generated as the full-charge detected signal when a charge amount of the battery 20 is above 14.6 V.

Next, the trickle oscillator 40 produces a driving signal for a trickle charge in response to a signal generated from the full-charge sensor 30.

That is, a trickle-charge signal generator 41 of the trickle oscillator 40 generates a driving signal for a trickle charge when a full-charge detected signal is generated from the full-charge sensor 30.

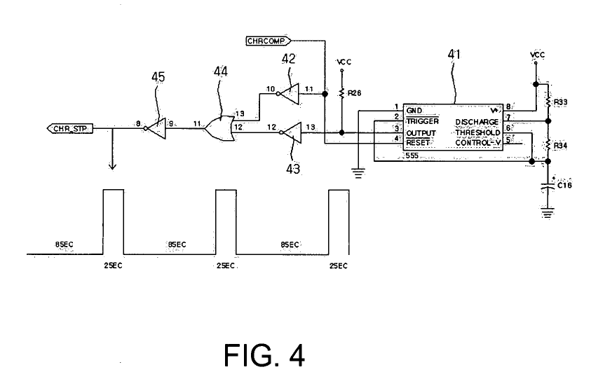

The driving signal for a trickle charge becomes phase-inverted by a second inverter 43 and the full-charge detected signal is phase-inverted by a first inverter 42. Next, the driving signal and the full-charge detected signal are OR-ed at an OR gate. The resulted signal from the OR gate is phase-inverted by a third inverter 45 and then, the final trickle charge signal is provided to the trickle driver 50. Moreover, the final trickle charge signal has a square waveform as shown in a lower part of FIG. 4. A drive voltage is generated by a current supplied from the zener diode D4

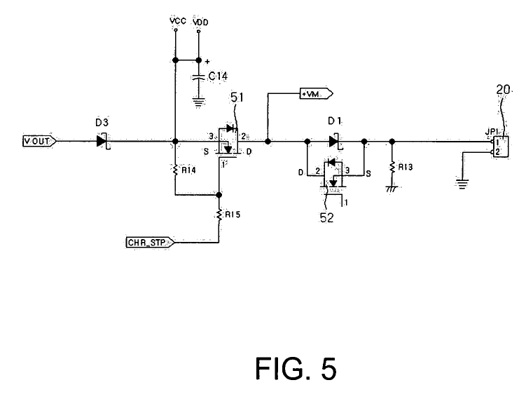

A zener diode D4 of the trickle driver 50 changes a voltage supplied from the constant-current supplier 10 into a constant voltage as shown in FIG. 5. Also, a drive field effect transistor (FET) 51 of the trickle driver 50 generates a drive voltage using a current supplied from the zener diode D4 according to a drive signal from the trickle oscillator 40. A charge FET 52 supplies a charge current to the battery 20 in response to a signal from the drive FET.

The rechargeable nail dryer of the invention minimizes a memory effect of the built-in rechargeable battery by simultaneously performing a constant-current equalizing charge, a full charge, a floating charge, and a trickle charge. Consequently, it is possible to prolong the built-on battery life and provide an optimized charging method.

The rechargeable nail dryer with an added charge circuit provides a convenient use and reduces the expense of replacing one-time use batteries by charging a built-in rechargeable battery.

Additionally, the rechargeable nail dryer minimizes a memory effect of the built-in battery by simultaneously performing a constant-current equalizing charge, a full charge, a floating charge, and a trickle charge. Consequently, it is possible to prolong the built-on battery life.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A rechargeable nail dryer, comprising:
a constant-current supplier (10) for supplying a charge voltage by making a current for a rechargeable battery (20) constant;
a full-charge sensor (30) for sensing a charge amount of the battery 20;
a trickle oscillator (40) for generating a driving signal of a trickle charge according to a full-charge detected signal generated from the full-charge sensor (30); and
a trickle driver (50) for trickle-charging a battery (20) with a current supplied from the constant-current supplier (10) according to a driving signal generated from the trickle oscillator (40).

2. The rechargeable nail dryer according to claim 1, wherein the trickle oscillator (40) comprises:
a trickle-charge signal generator (41) for generating a driving signal for a trickle charge when a full-charge detected signal is generated from the full-charge sensor (30);
a first inverter (42) for phase-inverting the full charge detected signal from the full-charge sensor (30);
a second inverter (43) for phase-inverting the driving signal from the trickle-charge signal generator (41);
an OR gate (44) for performing an OR-operation on signals from the first inverter (42) and the second inverter (43) and producing a result signal thereof; and
a third inverter (45) for producing a driving signal of trickle charge by phase-inverting the signal from the OR gate (44).

3. The rechargeable nail dryer according to claim 1, wherein the trickle driver (50) comprises:
a zener diode (D4) for changing a voltage supplied from the constant-current supplier (10) into a constant voltage;
a drive field effect transistor (FET) (51) for generating a drive voltage using a current supplied from the zener diode D4 according to a drive signal from the trickle oscillator (40); and
a charge FET (52) for supplying a charge current to the battery (20) in response to a signal from the drive FET.

4. The rechargeable nail dryer according to claim 2, wherein the trickle driver (50) comprises:
a zener diode (D4) for changing a voltage supplied from the constant-current supplier (10) into a constant voltage;
a drive field effect transistor (FET) (51) for generating a drive voltage using a current supplied from the zener diode D4 according to a drive signal from the trickle oscillator (40); and
a charge FET (52) for supplying a charge current to the battery (20) in response to a signal from the drive FET.
